(19) United States
(12) Patent Application Publication
(10) Pub. No.: US 2017/0229686 A1
(43) Pub. Date: Aug. 10, 2017

(54) BATTERY

(71) Applicant: TOYOTA JIDOSHA KABUSHIKI KAISHA, Toyota-shi (JP)

(72) Inventor: Junta TAKASU, Nagoya-shi (JP)

(73) Assignee: TOYOTA JIDOSHA KABUSHIKI KAISHA, Toyota-shi (JP)

(21) Appl. No.: 15/424,347

(22) Filed: Feb. 3, 2017

(30) Foreign Application Priority Data
Feb. 9, 2016 (JP) 2016-022517

(51) Int. Cl. H01M 2/06; H01M 2/30; H01M 10/658; H01M 2/26

(52) U.S. Cl. CPC H01M 2/06; H01M 2/26; H01M 2/30; H01M 10/658

(57) ABSTRACT

A battery includes a battery case, an external metallic member, an external resin member which is present between the battery case and the external metallic member, a heat transfer inhibiting portion configured to restrain heat transfer from the external metallic member to the external resin member, and a current collector member including an extending portion that extends from an inside of the battery case to an outside of the external metallic member, and a rivet portion that expands from the extending portion to a radially outer side and fixes the extending portion, the external metallic member, and the external resin member to the battery case. The rivet portion and the external metallic member include a weld bead that connects the rivet portion and the external metallic member with each other. The heat transfer inhibiting portion is provided on the axially inner side of the weld bead.

### INCORPORATION BY REFERENCE

The disclosure of Japanese Patent Application No. 2016-022517 filed on Feb. 9, 2016 including the specification, drawings and abstract is incorporated herein by reference in its entirety.

### BACKGROUND

1. Technical Field

The disclosure relates to a battery.

2. Description of Related Art

A battery, in which an electrode body is housed in a battery case, is known. In the battery, an extending portion of a current collector member connected with the electrode body inside the battery case is extended outside the battery case, and the extending portion of the current collector member and an external metallic member are fixed to the battery case through an external resin member by making riveting deformation of a rivet portion of the current collector member. The external metallic member is arranged outside the battery case and allows the extending portion to be inserted in its insertion hole (for example, Japanese Patent Application Publication No. 2014-11073 (JP 2014-11073 A)).

In the battery described in JP 2014-11073 A, the external metallic member and the rivet portion of the current collector member are welded, causing electrical conduction between them. The rivet portion of the current collector member covers a periphery of the insertion hole of the external metallic member annularly. To be more specific, an example is shown where the external metallic member and the peripheral edge part of the rivet portion are welded to each other by pulse laser beams like scattered dots (specifically, four dots in the circumference direction) (see FIG. 3, FIG. 5, and FIG. 6 in JP 2014-11073 A).

### SUMMARY

However, when spot-like weld beads are formed by irradiation with pulse-like energy beams such as laser beams and electron beams, parts of the external resin member immediately below the weld beads receive heat intensively from these weld beads through external metallic member, and temperature of these parts can be high. Then, in these parts, resin that forms the external resin member can be deteriorated due to the heat, which could cause a situation where adhesion between these parts and the external metallic member and/or adhesion between these parts and the battery case are impaired.

The disclosure provides a battery, in which an external metallic member and an external resin member are fixed to a battery case by using a rivet portion of a current collector member that extends to outside through the battery case, and the external metallic member and the rivet portion of the current collector member are connected with each other by weld beads. In this battery, it is possible to restrain deterioration of the external resin member caused by heat when the weld beads are formed.

A battery according to an aspect of the disclosure includes a battery case, an external metallic member, which is made of metal and arranged on an outer side of the battery case, an external resin member, which is made of resin, is present between the battery case and the external metallic member and is in close contact with the battery case and the external metallic member, a heat transfer inhibiting portion configured to restrain heat transfer from the external metallic member to the external resin member, a current collector member made of metal. The current collector member includes an extending portion that extends from an inside of the battery case to an outside of the external metallic member through a case insertion hole and a metallic member insertion hole, the case insertion hole extending through the battery case, and the metallic member insertion hole extending through the external metallic member, and a rivet portion that expands from the extending portion to a radially outer side of the case insertion hole, covers at least a part of a periphery of the metallic member insertion hole in the external metallic member, and fixes the extending portion, the external metallic member, and the external resin member to the battery case. The rivet portion of the current collector member and the external metallic member include a weld bead that connects the rivet portion and the external metallic member with each other. The weld bead is made of metal derived from the rivet portion and the external metallic member. When a direction towards an inner side of the battery case along the axis of the case insertion hole is regarded as an axially inner side, the heat transfer inhibiting portion is provided on the axially inner side of the weld bead.

Since this battery has the heat transfer inhibiting portion on the axially inner side of the weld bead for restraining heat transfer from the external metallic member to the external resin member, it is possible to restrain transfer of heat from the external metallic member to a part of the external resin member on the axially inner side of the weld bead when the weld bead is formed. Thus, it is possible to restrain a situation from happening where deformation or deterioration of resin in this part happens due to heat and the adhesion between the external metallic member and the external resin member and adhesion between the external resin member and the battery case are deteriorated.

The heat transfer inhibiting portion may be provided in at least either the external metallic member or the external resin member. This means that the heat transfer inhibiting portion may be provided in the external metallic member that is in contact with the external resin member, in the external resin member, or in the external metallic member and the external resin member. Further, the heat transfer inhibiting portion may be provided between the external metallic member and the external resin member.

In the foregoing aspect, the heat transfer inhibiting portion may be a part where thermal conductivity is lower than thermal conductivity of the metal that forms the external metallic member.

In the foregoing aspect, the heat transfer inhibiting portion may be a space that is provided in either the external metallic member or the external resin member for separating and thermally insulating the external metallic member and the external resin member from each other. To be more specific, the heat transfer inhibiting portion may be a resin recessed portion that is made in a part of the external resin member on the axially inner side of the weld bead so that a resin outer side surface facing the external metallic member is recessed and thus makes the external metallic member and the external resin member separated from each other. Further, the heat transfer inhibiting portion may be a metal recessed portion in the part of the external metallic member on the axially inner side of the weld bead (immediately below the weld bead) so that a metallic inner side surface facing the external resin member is recessed and thus makes the external metallic member and the external resin member separated from each other.

In addition, the heat transfer inhibiting portion may be in a form where a heat transfer inhibiting member is arranged in the metal recessed portion, the resin recessed portion, or in at least either the metal recessed portion or the resin recessed portion. The heat transfer inhibiting member may be made of a heat resistant material that has lower thermal conductivity than that of metal forming the external metallic member, such as metal (a carbon steel block, a porous metallic material when the external metallic member is made of copper) or ceramics (dense or porous ceramics such as alumina, mullite, and silicon nitride). Alternatively, the heat transfer inhibiting member may be provided in the external resin member on the axially inner side of the weld bead in the external metallic member.

The arrangement and form of the heat transfer inhibiting portion may be selected at least to meet a position of the weld bead formed. For example, in the case where a plurality of spot-like weld beads are provided so as to be separated from each other, the heat transfer inhibiting portions may be arranged in the external metallic member or the external resin member on the axially inner side of the weld beads, respectively. In addition, the heat transfer inhibiting portion may be provided annularly in the external metallic member or the external resin member so that the parts on the axially inner side of the weld beads are connected with each other.

In the foregoing aspect, the heat transfer inhibiting portion may be provided in at least either the external metallic member or the external resin member, and may be a recessed portion forming a space that separates and thermally insulates the external metallic member and the external resin member from each other on the axially inner side of the weld bead.

In this battery, the heat transfer inhibiting portion is formed more easily and inexpensively compared to the case where the heat transfer inhibiting member is interposed additionally.

Specifically, the form where the recessed portion is provided may be, as described earlier, the form where the metal recessed portion is provided in the external metallic member, the form where the resin recessed portion is provided in the external resin member, or the form where the metal recessed portion and the resin recessed portion are provided in the external metallic member and the external resin member, respectively.

Further, in the foregoing aspect, the heat transfer inhibiting portion may be made of a heat resistant material with lower thermal conductivity than that of metal that forms the external metallic member, may be present between the external metallic member and the external resin member on the axially inner side of the weld bead, and may be made of a heat transfer inhibiting member that restrains heat transfer from the external metallic member to the external resin member.

In the battery having the above structure, compared to the case where the heat transfer inhibiting portion is a recessed portion (space) provided in the external metallic member or the external resin member, pressure force due to riveting of the rivet portion is transferred evenly to the external resin member, thus making deformation of the external resin member unlikely.

Specifically, the form where the heat transfer inhibiting member is provided may be, the form where the heat transfer inhibiting member is arranged inside the metal recessed portion provided in the external metallic member, the form where the heat transfer inhibiting member is arranged inside the resin recessed portion of the external resin member, or the form where a part of the heat transfer inhibiting member is arranged in the metal recessed portion provided in the external metallic member and the rest of the heat transfer inhibiting member is arranged in the resin recessed portion provided in the external resin member.

Further, in the battery according to the foregoing aspect, the external metallic member and the current collector member having the extending portion and the rivet portion may be made of copper.

In the case where the external metallic member and the current collector member are made of copper, both thermal conductivity and melting point are higher compared to a case where, for example, the external metallic member and the current collector member are made of aluminum-based metal. Therefore, when forming the weld bead, it is necessary to increase an output of emitting laser compared to the case where the weld bead is formed between the external metallic member and the rivet portion of the current collector member made of aluminum. Then, it is more likely that heat is transferred from the weld bead to the axially inner side of the weld bead, and a situation is thus more likely to occur where adhesion is deteriorated at a part of the external resin member on the axially inner side of the weld bead.

On the contrary, since this battery has the heat transfer inhibiting portion, it is possible to restrain the situation where adhesion in the part of the external resin member on the axially inner side of the weld bead is deteriorated even when the external metallic member and the current collector member are made of copper. Copper may be oxygen free copper or tough pitch copper.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a perspective view of a battery according to an embodiment and first to sixth modifications;

FIG. 2 is a longitudinal sectional view of the battery according to the embodiment and the first to sixth modifications;

FIG. 3 is an exploded perspective view of a case lid with terminal members according to the embodiment;

FIG. 4 is a partial sectional view of a structure of the vicinity of a negative electrode terminal member in the battery according to the embodiment;

FIG. 5 is a partial plan view of a form of the vicinity of a negative electrode terminal member in the battery according to the embodiment and first to sixth modifications;

FIG. 6 is an enlarged partial sectional view according to the embodiment and taken along the arrows VI-VI in FIG. 5, the view showing a form in which recessed portions (heat transfer inhibiting portions) are provided in an external insulating member (external resin member) and weld beads are provided in a rivet portion of the current collector member and a negative electrode external member;

FIG. 7 is a plan view of the external insulating member (external resin member) according to the embodiment;

FIG. 8 is an explanatory view of forming of the weld beads using laser beams according to the embodiment;

FIG. 9 is an enlarged partial sectional view according to the first modification and taken along the arrows VI-VI in FIG. 5, the view showing a form in which recessed portions (heat transfer inhibiting portions) are provided in the negative electrode external member (external metallic member) and weld beads are provided in a rivet portion of a current collector member and the negative electrode external member;

FIG. 10 is an enlarged partial sectional view according to the second modification and taken along the arrows VI-VI in FIG. 5, the view showing a form in which recessed portions (heat transfer inhibiting portions) are provided in a negative electrode external member (external metallic member) and an external insulating member (external resin member), respectively, and weld beads are provided in a rivet portion of a current collector member and the negative electrode external member;

FIG. 11 is an enlarged partial sectional view according to the third modification and taken along the arrows VI-VI in FIG. 5, the view showing a form in which recessed portions are provided in an external insulating member (external resin member), porous ceramic blocks are inserted in the recessed portions, and weld beads are provided in a rivet portion of a current collector member and s negative electrode external member;

FIG. 12 is an enlarged partial sectional view according to the fourth modification and taken along the arrows VI-VI in FIG. 5, the view showing a form in which recessed portions are provided in a negative electrode external member (external metallic member), porous ceramic blocks are inserted in the recessed portions, and weld beads are provided in a rivet portion of a current collector member and the negative electrode external member;

FIG. 13 is an enlarged partial sectional view according to the fifth modification and taken along the arrows VI-VI in FIG. 5, the view showing a form in which recessed portions are provided in a negative electrode external member (external metallic member) and an external insulating member (external resin member), respectively, porous ceramic blocks are inserted in the two recessed portions, and weld beads are provided in a rivet portion of a current collector member and the external metallic member;

FIG. 14 is a plan view of a negative electrode resin member (external resin member) according to the sixth modification; and

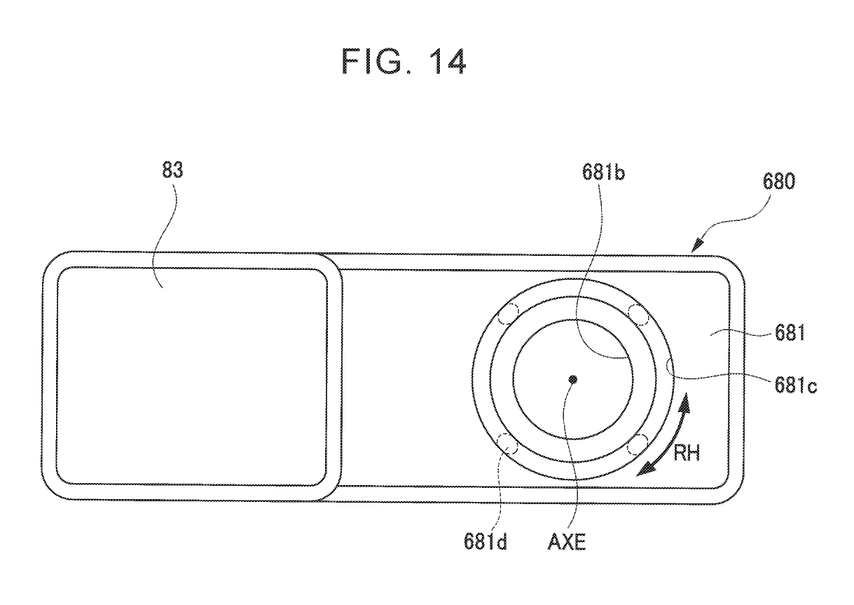

FIG. 15 is an enlarged partial sectional view according to the related art and taken along the arrows VI-VI in FIG. 5, the view showing a state in which no recessed portions are provided in a negative electrode external member (external metallic member) and an external insulating member (external resin member), and weld beads are provided in a rivet portion of a current collector member and the negative electrode external member.

### DETAILED DESCRIPTION OF EMBODIMENTS

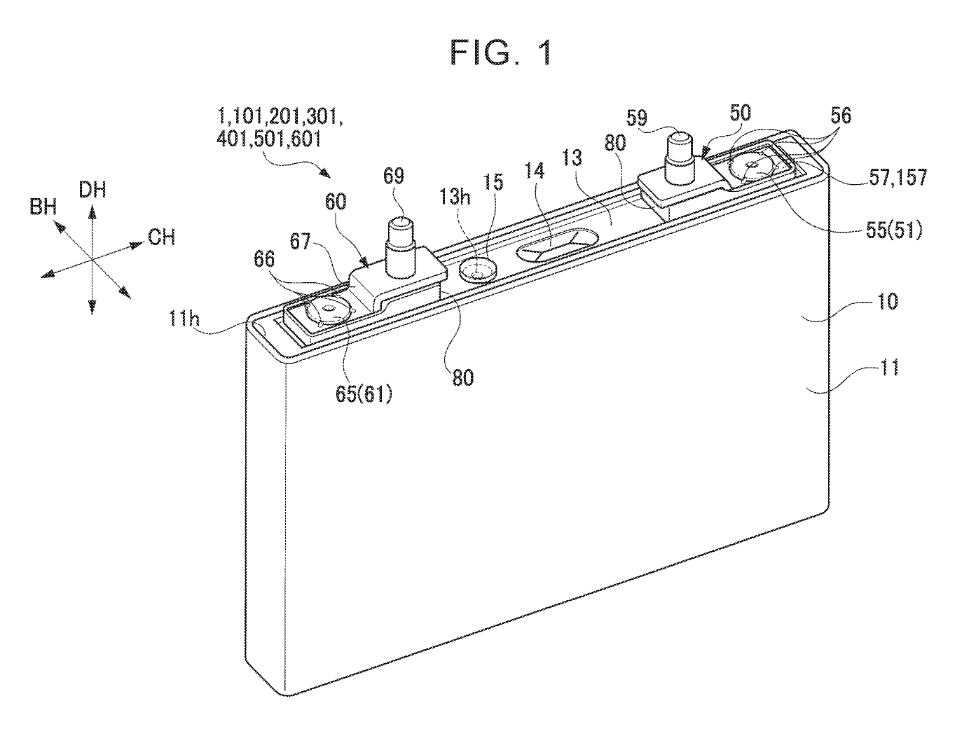

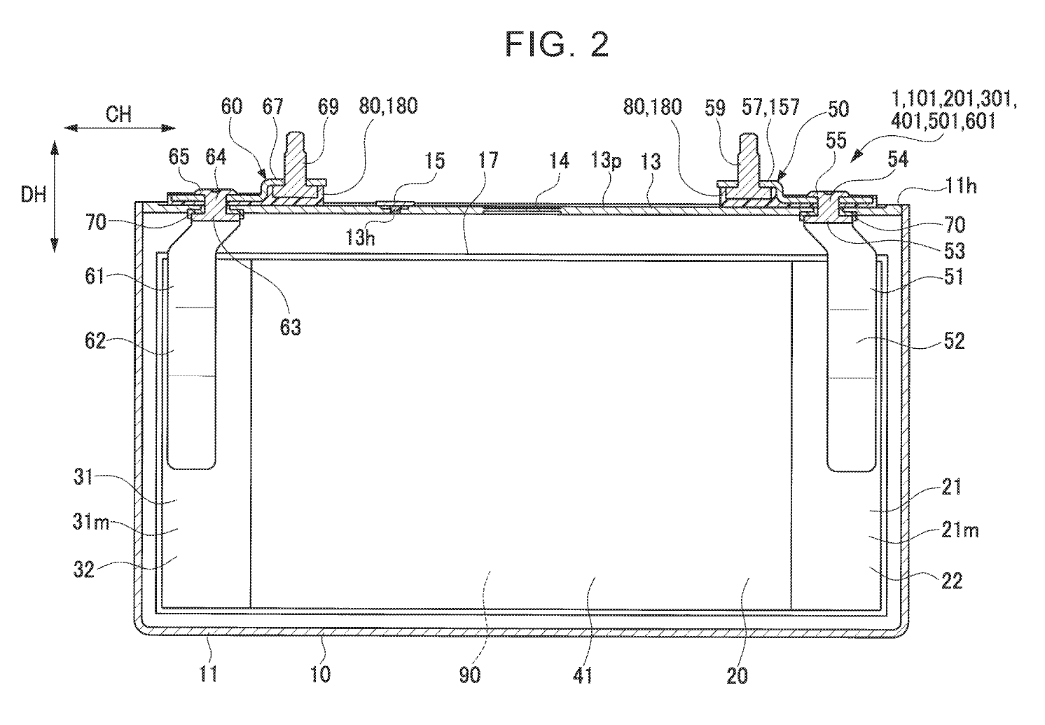

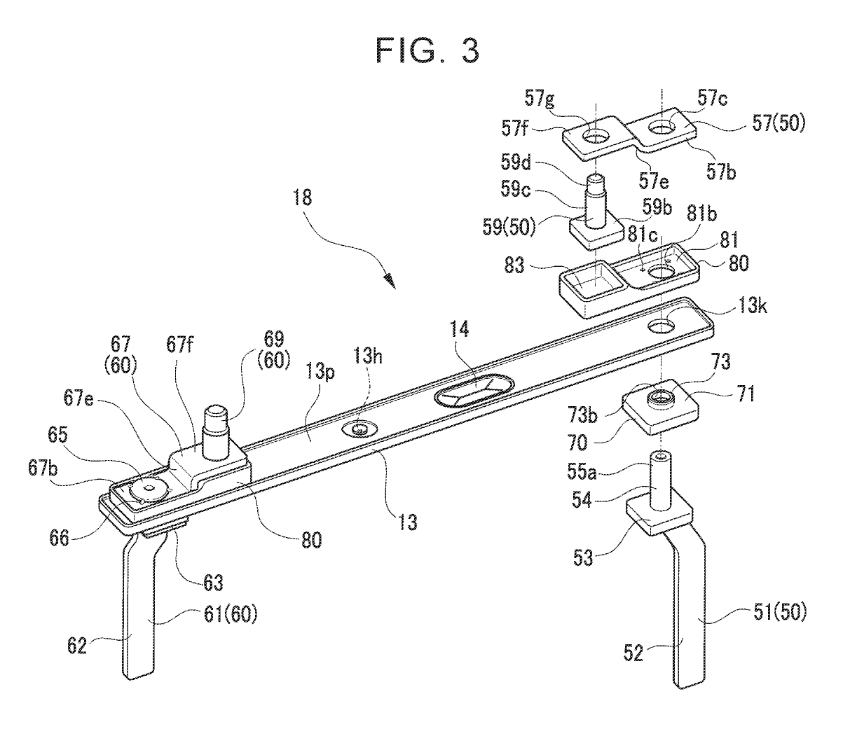

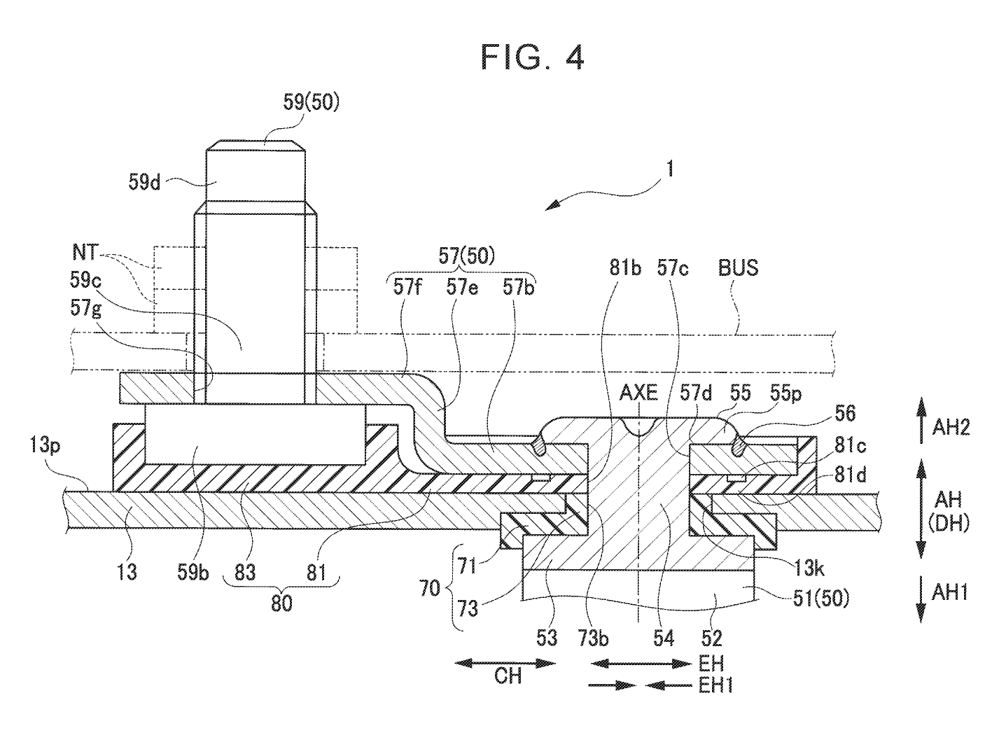

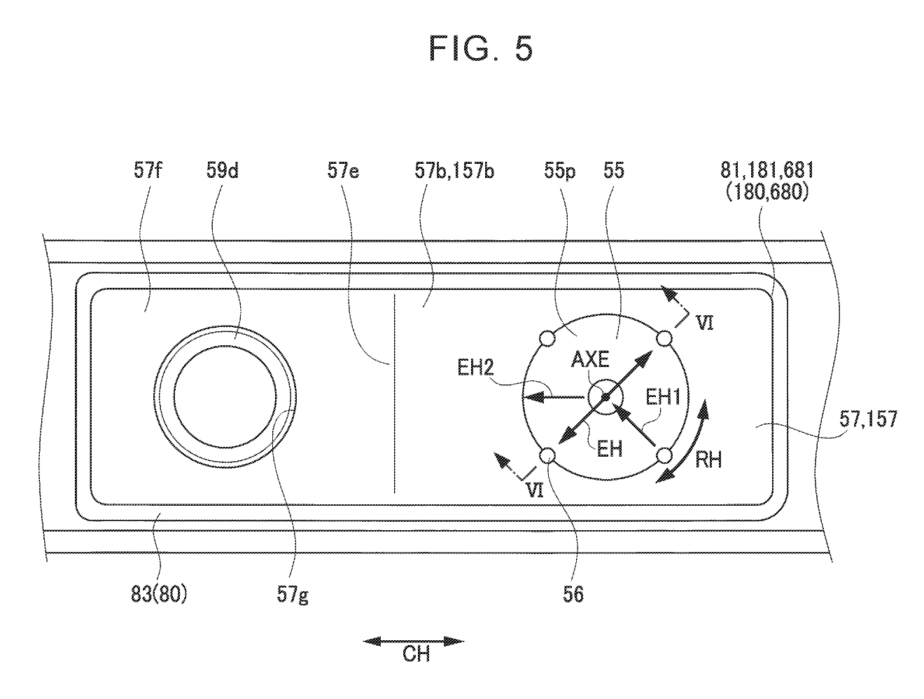

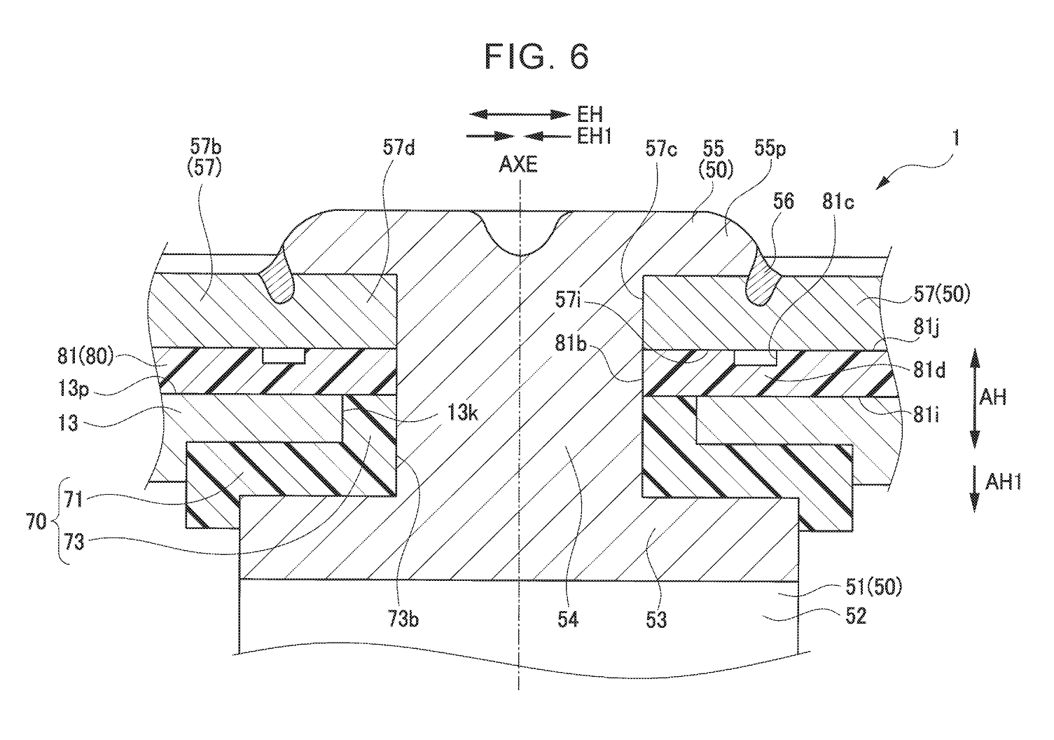

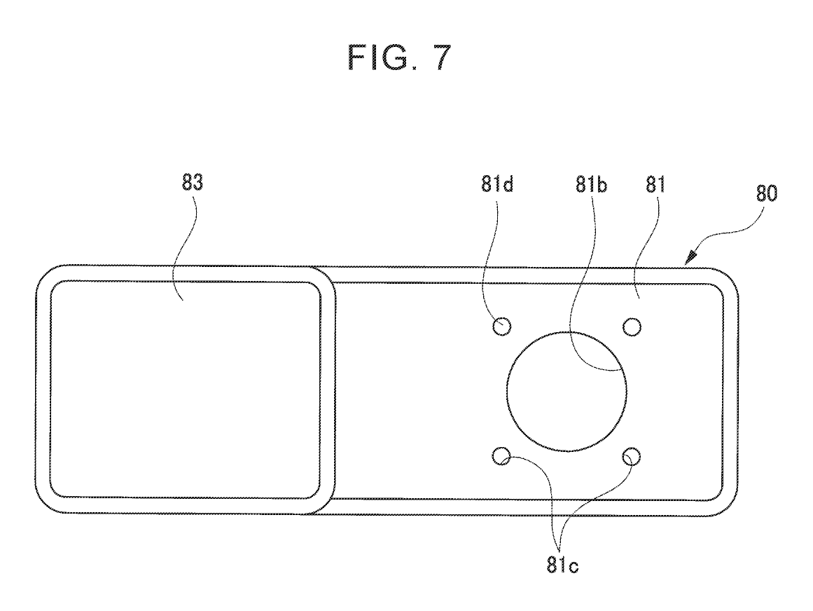

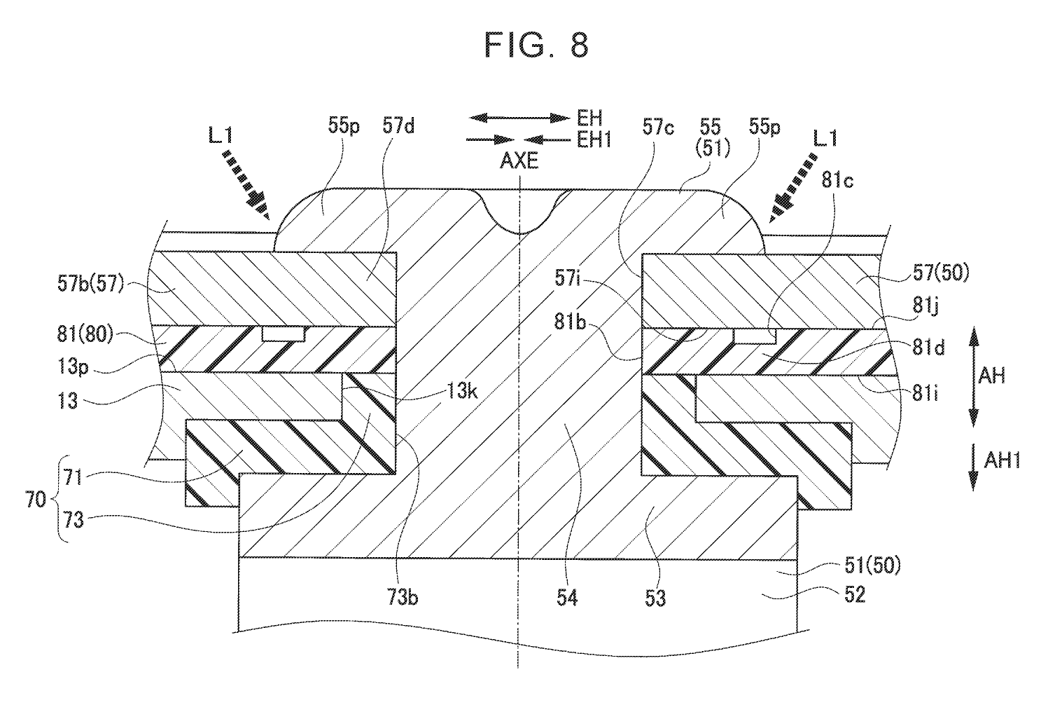

An embodiment of the disclosure is explained below with reference to the drawings. FIG. 1 and FIG. 2 are a perspective view and a longitudinal sectional view of a lithium-ion secondary battery (which is an example of a battery and is simply referred to as a “battery”) 1, respectively. FIG. 3 is an exploded perspective view of a case lid with terminal members, in which the terminal members 50, 60 are assembled to the case lid member 13. FIG. 4 is a partial sectional view of a structure of the vicinity of a negative electrode terminal member 50 in the battery 1. FIG. 5 is a partial plan view of a structure of the vicinity of the negative electrode terminal member 50 in the battery 1. FIG. 6 is an enlarged partial sectional view of an area where the negative electrode terminal member 50 extends from the battery case. FIG. 7 is a plan view of an external insulating member used in the battery 1. FIG. 8 is an explanatory view of forming of weld beads by using laser beams. In the explanation below, a battery thickness direction BH, a battery lateral direction CH, and a battery vertical direction DH of the battery 1 are determined as those illustrated in FIG. 1, FIG. 2 and so on.

The battery 1 is an angular shaped and sealed lithium-ion secondary battery installed in a vehicle such as a hybrid vehicle and an electric vehicle. The battery 1 includes a battery case 10, an electrode body 20 housed inside the battery case 10, the negative electrode terminal member 50 and the positive electrode terminal member 60 fixed to the battery case 10, and so on. An electrolyte (non-aqueous electrolyte) 90 is housed in the battery case 10, and a part of the electrolyte 90 is impregnated inside the electrode body 20.

The battery case 10 has a rectangular parallelepiped box shape and is made of metal (aluminum in the first embodiment). The battery case 10 includes a bottomed quadrangular cylindrical-shaped case body member 11 in which only an upper side is open, and a rectangular plate-shaped case lid member 13 that is welded to an opening 11h of the case body member 11 and closes the opening 11h. In the case lid member 13, a safety valve 14 is provided, which brakes and opens when inner pressure of the battery case 10 reaches predetermined pressure. A liquid injection hole 13h, which communicates inside and outside of the battery case 10, is formed in the case lid member 13 and is airtight sealed by a liquid injection hole sealing member 15.

The negative electrode terminal member 50 includes a negative electrode current collector member 51 made of oxygen free copper, a negative electrode external member 57, and a negative electrode connecting bolt 59. In the negative electrode terminal member 50, the negative electrode current collector member 51 and the negative electrode external member 57 are fixed to the case lid member 13 while being insulated from each other through an internal insulating member 70 and an external insulating member 80 made of insulating resin. Inside the battery case 10, one end of the negative electrode terminal member 50 (the negative electrode current collector member 51) is connected and has electrical conduction with a negative electrode exposed portion 21m of a negative electrode plate 21 in the electrode body 20 that is described later. The negative electrode terminal member 50 (the negative electrode current collector member 51) extends through the case lid member 13 and extends outside of the battery, and the other end of the negative electrode terminal member 50 (the negative electrode external member 57) structures a negative electrode terminal of the battery 1.

The positive electrode terminal member 60 includes a positive electrode current collector member 61 made of aluminum, a positive electrode external member 67, and a positive electrode connecting bolt 69. In the positive electrode terminal member 60, the positive electrode current collector member 61 and the positive electrode external member 67 are fixed to the case lid member 13 while being insulated from each other through an internal insulating member 70 and an external insulating member 80 made of an insulating resin. Inside the battery case 10, one end of the positive electrode terminal member 60 (the positive electrode current collector member 61) is connected and has electrical conduction with a positive electrode exposed portion 31m of a positive electrode plate 31 in the electrode body 20. The positive electrode terminal member 60 (the positive electrode current collector member 61) extends through the case lid member 13 and extends outside the battery, and the other end of the positive electrode terminal member 60 (the positive electrode external member 67) structures a positive electrode terminal of the battery 1.

Next, the electrode body 20 is explained (see FIG. 2). The electrode body 20 has a flat shape and is housed inside the battery case 10 so that the axis of the electrode body 20 is parallel with the battery lateral direction CH (a state where the longitudinal direction coincides with the lateral direction). Between the electrode body 20 and the battery case 10, a bag-like film enclosing body 17 is arranged, which is made of an insulating film and has an opening on one end side (the upper side in FIG. 2), thereby insulating the electrode body 20 and the battery case 10 from each other. The electrode body 20 is made as follows. The belt-like negative electrode plate 21 and the belt-like positive electrode plate 31 are layered on top of each other through a pair of belt-like separators 41, 41, wound around the axis, and compressed into a flat shape.

In the electrode body 20, the negative electrode exposed portion 21m is provided on one axial side (the right side in FIG. 2). In the negative electrode exposed portion 21m, negative electrode current collector foil 22 of the negative electrode plate 21 is exposed. On the other axial side (the left side in FIG. 2), the positive electrode exposed portion 31m is provided, in which positive electrode current collector foil 32 of the positive electrode plate 31 is exposed. A current collector portion 52 of the foregoing negative electrode current collector member 51 is welded to the negative electrode exposed portion 21m. Also, a current collector portion 62 of the foregoing positive electrode current collector member 61 is welded to the positive electrode exposed portion 31m.

As shown in FIG. 1 to FIG. 3, the negative electrode current collector member 51 in the negative electrode terminal member 50 has the current collector portion 52, which is arranged inside the battery case 10, and an extending portion 54 that extends from the current collector portion 52 to outside of the battery case 10. The current collector portion 52 is welded to the negative electrode exposed portion 21m, and also includes an engaging portion 53 that is engaged with the case lid member 13 through the rectangular plate-shaped internal insulating member 70 that is described later. The extending portion 54 has a solid columnar shape extending from the center of the engaging portion 53 of the current collector portion 52. A distal end portion of the extending portion 54 has a cylindrical shape, and is a portion to be riveted 55a, which will be deformed by riveting as described later.

As shown in FIG. 3, the negative electrode external member 57 of the negative electrode terminal member 50 is made of a plate material that is bent into a crank shape, and includes a flat plate-shaped riveting seat portion 57b, which serves as a seat for a later-described rivet portion 55, a step portion 57e bent into a step shape, and a flat plate-shaped external terminal abutting portion 57f with which a negative electrode connecting bolt 59, which is described next, is engaged and an external terminal such as a bus bar BUS comes into contact. In the riveting seat portion 57b, an extending portion insertion hole 57c is made, through which the extending portion 54 of the negative electrode current collector member 51 is inserted. Further, in the external terminal abutting portion 57f, a bolt insertion hole 57g is made, through which an external thread portion 59c of the negative electrode connecting bolt 59 is inserted.

As shown in FIG. 3, the negative electrode connecting bolt 59 of the negative electrode terminal member 50 includes a rectangular plate-shaped head portion 59b, the external thread portion 59c that extends from the center part of the head portion 59b and has an external thread formed, and a columnar-shaped shaft portion 59d positioned at a distal end portion of the external thread portion 59c.

The internal insulating member 70 is made of resin that is electrically insulating and elastically deformable, and includes a cover portion 71 that covers the engaging portion 53 of the negative electrode current collector member 51 from the upper side in the battery vertical direction DH (the upper side in FIG. 3) and insulates the engaging portion 53 and the case lid member 13 from each other, and a cylindrical projecting portion 73 that projects in a cylindrical shape from the center of the cover portion 71 and surrounds the extending portion 54 of the negative electrode current collector member 51 inserted into an extending portion insertion hole 73b on the inner side. The extending portion 54 and the cylindrical projecting portion 73 that surrounds the extending portion 54 are inserted into a case insertion hole 13k of the case lid member 13, and the cylindrical projecting portion 73 insulates the extending portion 54 and the case insertion hole 13k of the case lid member 13 from each other.

The external insulating member 80 is also made of resin that is electrically insulating and elastically deformable (specifically, nylon resin), and abuts on an upper surface 13p of the case lid member 13. The external insulating member 80 is present between the riveting seat portion 57b of the negative electrode external member 57 and the head portion 59b of the negative electrode connecting bolt 59, and the upper surface 13p of the case lid member 13, thereby insulating them from each other. The external insulating member 80 has a recessed-shaped seat portion holder 81 that receives the riveting seat portion 57b of the negative electrode external member 57, and a recessed-shaped head portion holder 83 that receives the head portion 59b of the negative electrode connecting bolt 59. An extending portion insertion hole 81b is made approximately at the center of the seat portion holder 81 for the extending portion 54 of the negative electrode current collector member 51 to be inserted through it.

As shown in FIG. 3, in the battery 1, the engaging portion 53 of the negative electrode current collector member 51, the internal insulating member 70, the case lid member 13, the external insulating member 80, and the negative electrode external member 57 are layered in this order, and the extending portion 54 of the negative electrode current collector member 51 passes through the extending portion insertion hole 73b of the internal insulating member 70, the case insertion hole 13k of the case lid member 13, the extending portion insertion hole 81b of the external insulating member 80, and the extending portion insertion hole 57c of the negative electrode external member 57. The portion to be riveted 55a at the distal end of the extending portion 54 of the negative electrode current collector member 51 is deformed into a shape like an umbrella that expands outwardly by riveting, thereby becoming the rivet portion 55.

A direction along the central axis AXE of the case insertion hole 13k of the case lid member 13 is denoted as an axis direction AH, a radial direction, a radially inner side, and a radially outer side of the central axis AXE are denoted as EH, EH1, and EH2, respectively, and a circumferential direction of the central axis AXE is denoted as the circumferential direction RH. Then, the rivet portion 55 expands from the extending portion 54 towards the radially outer side EH2 due to the riveting deformation, annularly covers an insertion hole surrounding portion 57d around the extending portion insertion hole 57c of the negative electrode external member 57, and fixes the extending portion 54 and the negative electrode external member 57 to the battery case 10. Also, because of this, the engaging portion 53 of the negative electrode current collector member 51 and the cover portion 71 of the internal insulating member 70, the cover portion 71 and the case lid member 13, the case lid member 13 and the seat portion holder 81 of the external insulating member 80, the seat portion holder 81 and the negative electrode external member 57, and the negative electrode external member 57 and the rivet portion 55 are adhered closely to one another, respectively, thereby keeping the case lid member 13 and the negative electrode current collector member 51, which is inserted through the case insertion hole 13k, sealed.

It is not possible to remove the negative electrode connecting bolt 59 because the head portion 59b of the negative electrode connecting bolt 59 is housed in the head portion holder 83 of the external insulating member 80, and the external thread portion 59c is inserted through the bolt insertion hole 57g of the negative electrode external member 57.

Also, in the positive electrode, the positive electrode terminal member 60 (the positive electrode current collector member 61, the positive electrode external member 67, and the positive electrode connecting bolt 69) that is made of aluminum in a similar form is fixed to the case lid member 13 as a rivet portion 65 of the positive electrode current collector member 61 is formed, while being kept insulated by the internal insulating member 70 and the external insulating member 80.

Further, in the battery 1 according to the embodiment, the rivet portion 55 of the negative electrode current collector member 51 and the riveting seat portion 57b of the negative electrode external member 57 are welded to each other by using laser beams to give electrical conduction between them, thereby reducing conduction resistance between the negative electrode current collector member 51 and the negative electrode external member 57 (see FIG. 1 and FIG. 4 to FIG. 6). Specifically, as shown in FIG. 4 to FIG. 6, four weld beads 56 are formed in an outer peripheral portion 55p of the rivet portion 55 so as to be separated from each other in the circumferential direction RH of the extending portion insertion hole 57c. The weld beads 56 are made by welding the outer peripheral portion 55p of the rivet portion 55 and the negative electrode external member 57 to each other and give electrical conduction between them.

In the embodiment, the vicinity of the boundary between the outer peripheral portion 55p of the rivet portion 55 and the riveting seat portion 57b of the negative electrode external member 57 is irradiated with pulse-like laser beams L1, thereby forming the weld beads 56 in a circular spot shape in a plan view (see FIG. 5). The weld beads 56 are made of metal derived from the rivet portion 55 and the negative electrode external member 57. However, in the negative electrode, because the negative electrode current collector member 51 (the rivet portion 55) and the negative electrode external member 57 (the riveting seat portion 57b) are both made of oxygen free copper, the weld beads 56 are also made of oxygen free copper.

Similarly, in the positive electrode, weld beads 66 are formed by welding the rivet portion 65 of the positive electrode current collector member 61 and a riveting seat portion 67b of the positive electrode external member 67 to each other by using laser beams. The weld beads 66 allow the positive electrode current collector member 61 and the positive electrode external member 67 to have electrical conduction between them, thereby reducing conduction resistance between them. However, in the positive electrode, the weld beads 66 that are formed are made of mixed metal of pure aluminum, which forms the positive electrode current collector member 61, and an Al—Mg based aluminum alloy, which forms the positive electrode external member 67, and have an intermediate coefficient of thermal expansion between pure aluminum and the Al—Mg based aluminum alloy.

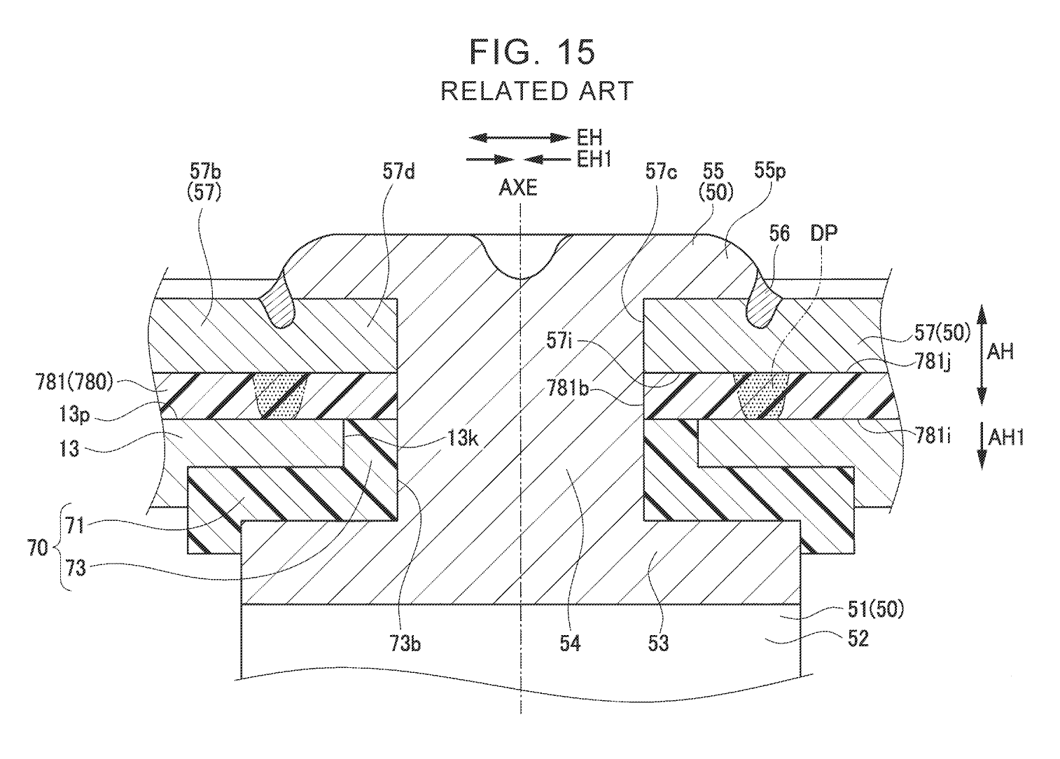

When the weld beads 56 are formed by irradiation of the laser beams L1 as stated above, the riveting seat portion 57b is heated because of energy of the irradiated laser beams L1, and the heat is transferred towards the axially inner side AH1 of the axis direction AH. Therefore, in the related art as shown in FIG. 15, the heat is also transferred to deteriorated parts DP on the axially inner side AH1 of the weld beads 56 within a seat portion holder 781 of an external insulating member 780 located on the axially inner side AH1 of the riveting seat portion 57b. Then, in the deteriorated parts DP, temperature of resin that forms the external insulating member 780 (the seat portion holder 781) (nylon resin in this embodiment) becomes high (in some cases, the temperature becomes higher than heat resistance temperature of the resin), causing deterioration (settling, contraction and so on). Specifically, in the deteriorated parts DP, resin that forms the external insulating member 780 is thermally deformed. Because of this, adhesion between an inner side surface 57i of the riveting seat portion 57b of the negative electrode external member 57 and an outer side surface 781j of the seat portion holder 781 of the external insulating member 780 could be reduced in the deteriorated parts DP. Further, adhesion between an inner side surface 781i of the seat portion holder 781 of the external insulating member 780 and the upper surface 13p of the case lid member 13 of the battery case 10 could be reduced in the deteriorated parts DP. Thus, sealing performance between the case lid member 13 and the negative electrode current collector member 51, which is inserted through the case insertion hole 13k, could be deteriorated.

Therefore, in the battery 1 according to the embodiment, as shown in FIG. 6 and FIG. 7, (in the embodiment, four) resin recessed portions 81c are provided by making the outer side surface 81j recessed in a columnar shape in the seat portion holder 81 of the external insulating member 80 at positions on the axially inner side AH1 of the weld beads 56. Therefore, it is possible to prevent heat transfer from the weld beads 56 to direct lower parts 81d on the axially inner side AH1 of the weld beads 56 in the seat portion holder 81 through the riveting seat portion 57b of the negative electrode external member 57 due to irradiation of the laser beams L1. Thus, it is possible to restrain deterioration of the direct lower parts 81d due to heat.

Especially, in the battery 1 according to the embodiment, as stated earlier, the negative electrode current collector member 51 (the rivet portion 55) and the negative electrode external member 57 (the riveting seat portion 57b) are both made of oxygen free copper. Oxygen free copper has higher melting point (1083° C.) and thermal conductivity (390 W/m·K) than those of aluminum that forms the positive electrode current collector member 61 and the positive electrode external member 67. Therefore, higher laser power is required for welding using laser and so on compared to the case of aluminum. Hence, it is more likely that a larger amount of heat is transferred from the weld beads 56 to the direct lower parts 81d in the seat portion holder 81 on the axially inner side AH1 of the weld beads 56, thus causing a higher possibility of adhesion deterioration.

However, in the battery 1 according to the embodiment, the resin recessed portions 81c are made in the seat portion holder 81 in the recessed fashion as stated earlier, and it is thus possible to restrain heat transfer to the direct lower parts 81d. It is especially possible to restrain deterioration of the direct lower parts 81d from happening due to heat.

Although not shown, in the positive electrode, (in the embodiment, four) resin recessed portions 81c are also formed by making the outer side surface 81j recessed in a columnar shape in the seat portion holder 81 of the external insulating member 80 at positions on the axially inner side AH1 of the weld beads 66 (see FIG. 1 and FIG. 3). Therefore, it is possible to prevent heat transfer from the weld beads 66 to direct lower parts 81d in the seat portion holder 81 on the axially inner side AH1 of the weld beads 66 through the riveting seat portion 67b of the positive electrode external member 67 due to irradiation of the laser beams L1. Thus, it is possible to restrain deterioration of the direct lower parts 81d due to heat.

The battery 1 according to the embodiment is manufactured as follows. First of all, the case lid member 13, the negative electrode terminal member 50 (51, 57, 59), the positive electrode terminal member 60 (61, 67, 69), the internal insulating members 70, and the external insulating members 80 are prepared. As shown in FIG. 3, the engaging portion 53 of the negative electrode current collector member 51 is covered by the cover portion 71 of the internal insulating member 70, and the extending portion 54 of the negative electrode current collector member 51 is inserted through the extending portion insertion hole 73b of the internal insulating member 70, the case insertion hole 13k of the case lid member 13, the extending portion insertion hole 81b of the external insulating member 80, and the extending portion insertion hole 57c of the negative electrode external member 57. Further, the head portion 59b of the negative electrode connecting bolt 59 is housed in the head portion holder 83 of the external insulating member 80, and the external thread portion 59c is inserted through the bolt insertion hole 57g of the negative electrode external member 57. Here, the portion to be riveted 55a, which is located at the distal end of the extending portion 54 and extends from the negative electrode external member 57, is deformed by riveting so as to expand to the radially outer side EH2 into an umbrella shape, thereby forming the rivet portion 55. Thus, the internal insulating member 70, the case lid member 13, the external insulating member 80, and the negative electrode external member 57 are held between the engaging portion 53 and the rivet portion 55 of the negative electrode current collector member 51. As a result, the negative electrode current collector member 51 and the negative electrode external member 57 of the negative electrode terminal member 50 are fixed to the case lid member 13. It is not possible to remove the negative electrode connecting bolt 59 as the head portion 59b is engaged with the external terminal abutting portion 57f.

In the positive electrode, a portion to be riveted (now shown) is also deformed by riveting in a similar manner to form the rivet portion 65. Thus, the internal insulating member 70, the case lid member 13, the external insulating member 80, and the positive electrode external member 67 are held between the engaging portion 63 and the rivet portion 65 of the positive electrode current collector member 61. As a result, the positive electrode current collector member 61 and the positive electrode external member 67 of the positive electrode terminal member 60 are fixed to the case lid member 13.

Next, as shown in FIG. 8, a part of the outer peripheral portion 55p of the rivet portion 55 in the circumferential direction RH and the riveting seat portion 57b of the negative electrode external member 57 are irradiated with a spot-like laser beam L1 so that the beam extends across both of them. Thus, the weld bead 56, which welds the outer peripheral portion 55p of the rivet portion 55 and the negative electrode external member 57 to each other, is formed at a previously determined position. This is performed at four positions around the rivet portion 55. The external insulating member 80 used here is provided with the resin recessed portions 81c in the outer side surface 81j of the seat portion holder 81 at positions where the weld beads 56 are formed (four positions in this embodiment) as shown in FIG. 3 and FIG. 5. Therefore, even when the weld beads 56 are formed by irradiation of laser beams L1, it is possible to restrain deterioration of resin in the direct lower parts 81d because there are the resin recessed portions 81c that prevent heat transfer to the direct lower parts 81d of the external insulating member 80.

The rest parts of the battery 1 may be manufactured by using a known method. For example, the current collector portion 52 of the negative electrode current collector member 51 in the case lid with terminal members 18 is welded to the negative electrode exposed portion 21m of the electrode body 20, which is formed separately in advance using a known method. Also, the current collector portion 62 of the positive electrode terminal member 60 is welded to the positive electrode exposed portion 31m of the electrode body 20. Then, the electrode body 20 is covered with the film enclosing body 17, and the electrode body 20 and the film enclosing body 17 are inserted into the case body member 11, and the opening 11h of the case body member 11 is covered with the case lid member 13. Then, the case body member 11 and the case lid member 13 are welded by laser in the entire circumference. Thereafter, the electrolyte 90 is injected from the liquid injection hole 13h, and the liquid injection hole 13h is airtight-sealed by the liquid injection hole sealing member 15. Next, initial charge and various tests are performed on the battery 1. As a result, the battery 1 is completed.

In the first modification of the embodiment, a battery 101 is explained. In the embodiment described above, the resin recessed portions 81c are made in the seat portion holder 81 of the external insulating member 80 so that the outer side surface 81j is recessed in a columnar shape at positions on the axially inner side AH1 of the weld beads 56.

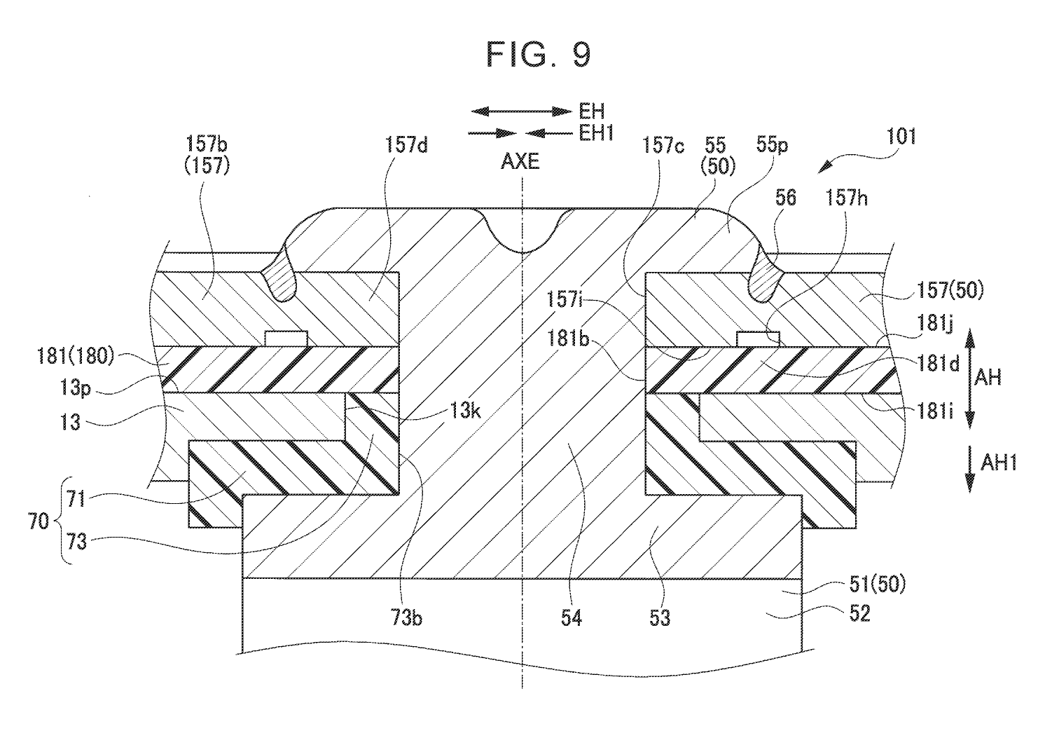

Meanwhile, in the first modification, as shown in FIG. 9, resin recessed portions, which are recessed portions in an outer side surface 181j, are not provided in a seat portion holder 181 of an external insulating member 180. Instead, metal recessed portions 157h are provided in an insertion hole surrounding portion 157d around an extending portion insertion hole 157c in a riveting seat portion 157b of a negative electrode external member 157 so that an inner side surface 157i is recessed in a columnar shape at positions (four positions in the first modification) on the axially inner side AH1 of the weld beads 56.

Therefore, it is possible to prevent transfer of heat due to irradiation of laser beams L1 from the weld beads 56 to direct lower parts 181d in the seat portion holder 181 on the axially inner side AH1 of the weld beads 56 through the riveting seat portion 157b of the negative electrode external member 157. Thus, it is possible to restrain deterioration of the direct lower parts 181d due to the heat.

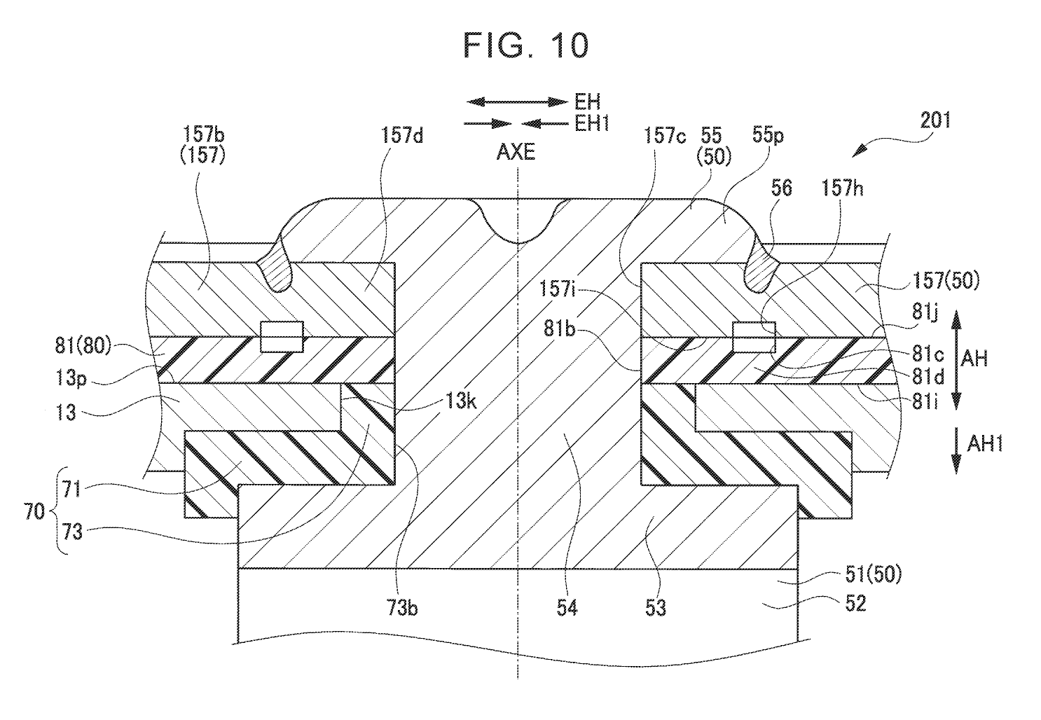

In the second modification of the embodiment, a battery 201 is explained. In the foregoing embodiment, the resin recessed portions 81c are provided, and, in the first modification, the metal recessed portions 157h are provided. However, it is possible to provide both of them. This means that, in the second modification, as shown in FIG. 10, the resin recessed portions 81c are provided in the seat portion holder 81 of the external insulating member 80 so that the outer side surface 81j is recessed in a columnar shape at positions (four positions in the second modification) on the axially inner side AH1 of the weld beads 56, similarly to the embodiment. In addition, similarly to the first modification, in the riveting seat portion 157b of the negative electrode external member 157, the metal recessed portions 157h are provided in the insertion hole surrounding portion 157d around the extending portion insertion hole 157c so that the inner side surface 157i is recessed in a columnar shape at positions on the axially inner side AH1 of the weld beads 56. As a result, the resin recessed portions 81c and metal recessed portions 157h are arranged so as to face each other, respectively.

By doing so, it is possible to further prevent transfer of heat due to irradiation of laser beams L1 from the weld beads 56 to the direct lower parts 81d in the seat portion holder 81 on the axially inner side AH1 of the weld beads 56 through the riveting seat portion 157b of the negative electrode external member 157. Thus, it is possible to restrain deterioration of the direct lower parts 81d caused by the heat.

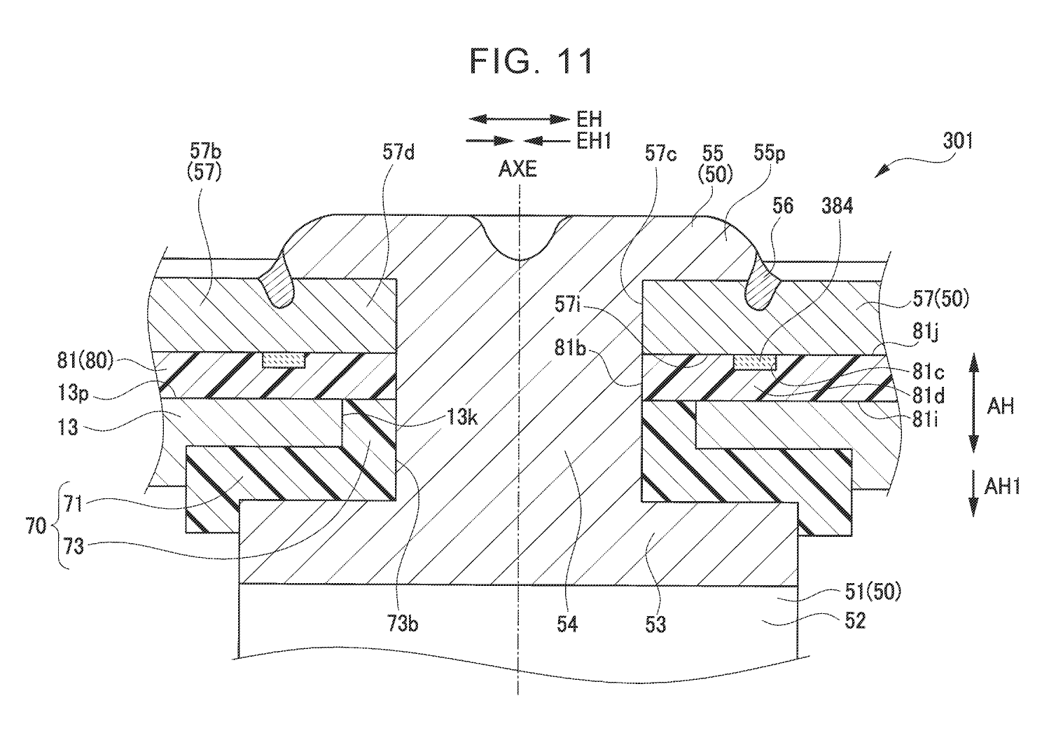

In the third modification of the embodiment, a battery 301 is explained. In the battery 1 according to the embodiment, the resin recessed portions 81c provided in the seat portion holder 81 of the external insulating member 80 have nothing inside and are left as empty spaces (see FIG. 6). Meanwhile, in the third modification, as shown in FIG. 11, a heat transfer inhibiting block 384, which has a columnar shape and is made of porous alumina, is fitted into each of the resin recessed portions 81c. Therefore, it is possible to prevent transfer of heat due to irradiation of laser beams L1 from the weld beads 56 to the direct lower parts 81d in the seat portion holder 81 on the axially inner side AH1 of the weld beads 56 through the riveting seat portion 57b of the negative electrode external member 57. Thus, it is possible to restrain deterioration of the direct lower parts 81d caused by the heat. In addition, since the heat transfer inhibiting blocks 384 are fitted into the resin recessed portions 81c, pressure force applied by riveting of the rivet portion 55 is transferred evenly to the seat portion holder 81 of the external insulating member 80, which is advantageous in that deformation of the seat portion holder 81 becomes unlikely.

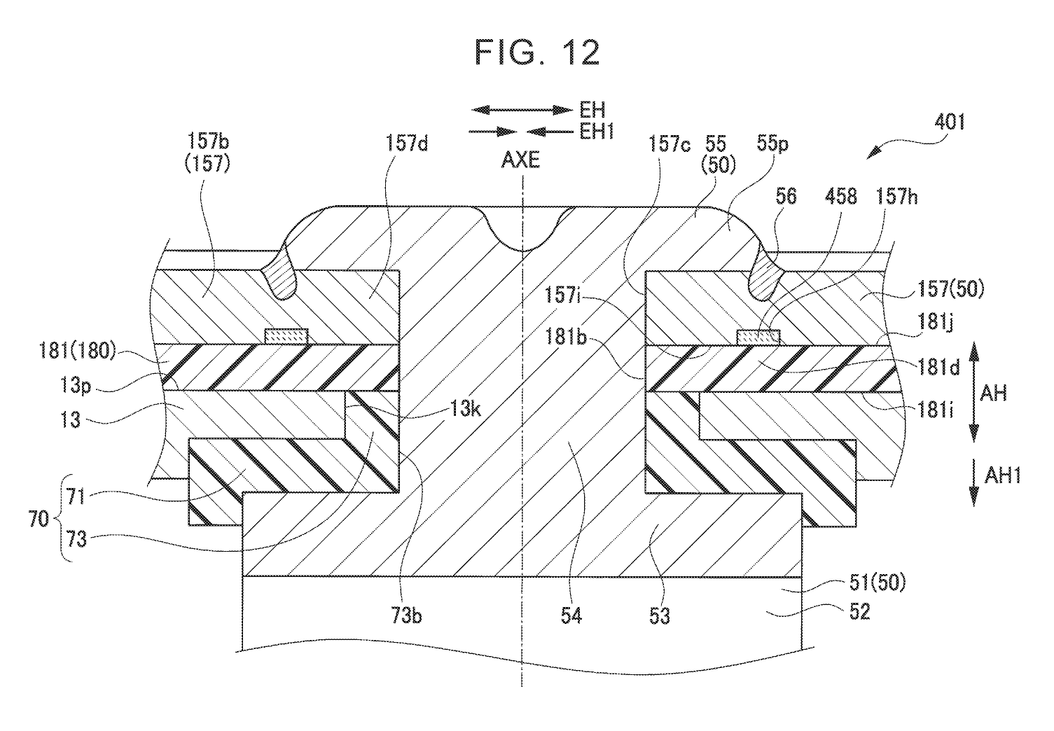

In the fourth modification of the embodiment, a battery 401 is explained. In the third modification, the heat transfer inhibiting blocks 384 are fitted into the resin recessed portions 81c that are provided in the seat portion holder 81 similarly to the embodiment. Meanwhile, in the fourth modification, as shown in FIG. 12, heat transfer inhibiting block 458, which has a columnar shape and is made of porous alumina, is fitted into each of the columnar-shaped metal recessed portions 157h that are provided in the riveting seat portion 157b of the negative electrode external member 157 similarly to the first modification.

Therefore, it is possible to prevent transfer of heat due to irradiation of laser beams L1 from the weld beads 56 to the direct lower parts 181d in the seat portion holder 181 on the axially inner side AH1 of the weld beads 56 through the riveting seat portion 157b of the negative electrode external member 157. Thus, it is possible to restrain deterioration of the direct lower parts 181d caused by the heat. In addition, since the heat transfer inhibiting blocks 458 are fitted into the metal recessed portions 157h, pressure force applied by riveting of the rivet portion 55 is transferred evenly to the seat portion holder 181 of the external insulating member 180, which is advantageous in that deformation of the seat portion holder 181 becomes unlikely.

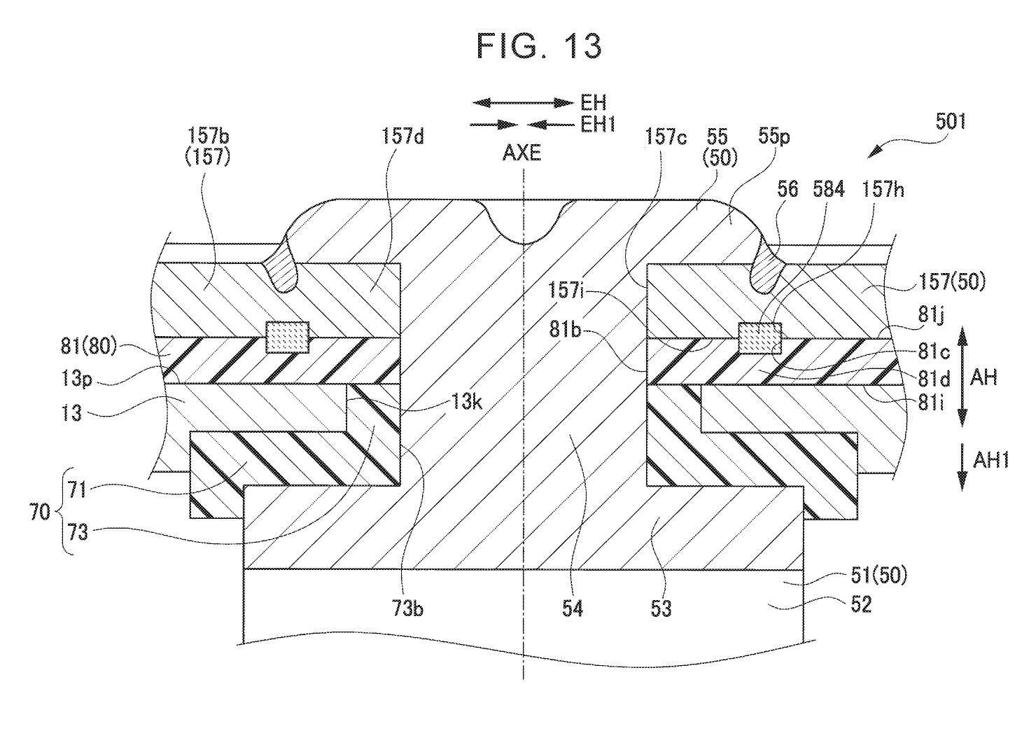

In the fifth modification of the embodiment, a battery 501 is explained. In the third modification, the heat transfer inhibiting blocks 384 are inserted into the resin recessed portions 81c, respectively. In the fourth modification, the heat transfer inhibiting blocks 458 are inserted into the metal recessed portions 157h, respectively. However, both the resin recessed portions 81c and the metal recessed portions 157h may be provided at the same time, and the heat transfer inhibiting blocks may be inserted in them, respectively. This means that, in the fifth modification, as shown in FIG. 13, the resin recessed portions 81c are provided in the seat portion holder 81 of the external insulating member 80 so that the outer side surface 81j is recessed in a columnar shape at positions on the axially inner side AH1 of the weld beads 56, similarly to the second modification. In addition, the metal recessed portions 157h are provide in the insertion hole surrounding portion 157d of the negative electrode external member 157 so that the inner side surface 157i is recessed in a columnar shape at positions on the axially inner side AH1 of the weld beads 56. Then, heat transfer inhibiting blocks 584 are fitted into the resin recessed portions 81c and the metal recessed portions 157h that are arranged to face each other, respectively.

Therefore, it is possible to prevent transfer of heat due to irradiation of laser beams L1 from the weld beads 56 to the direct lower parts 181d in the seat portion holder 181 on the axially inner side AH1 of the weld beads 56 through the riveting seat portion 157b of the negative electrode external member 157. Thus, it is possible to restrain deterioration of the direct lower parts 181d caused by the heat. In addition, since the heat transfer inhibiting blocks 584 are fitted into the metal recessed portions 157h and the resin recessed portions 81c, respectively, pressure force applied by riveting of the rivet portion 55 is transferred evenly to the seat portion holder 81 of the external insulating member 80, which is advantageous in that deformation of the seat portion holder 81 becomes unlikely.

In the sixth modification of the embodiment, a battery 601 is explained. In the embodiment and the second, third, and fifth modifications, four resin recessed portions 81c are provided in a recessed fashion in the seat portion holder 81 of the external insulating member 80. On the contrary, in the sixth modification, a resin recessed portion 681c, which is made of a ring-shaped recessed groove that annularly connects the four positions on the axially inner side AH1 of the weld beads 56, is made in a recessed fashion in a seat portion holder 681 of an external insulating member 680. In this way, it is also possible to prevent transfer of heat to direct lower parts 681d of the seat portion holder 681 on the axially inner side AH1 of the weld beads 56, and it is thus possible to prevent the direct lower parts 681d from deteriorating due to heat.

In the foregoing, the disclosure is explained based on the embodiment and first to sixth modifications. However, the disclosure is not limited to the foregoing embodiment and so on, and it is obvious that changes may be applied as appropriate without departing from the gist of the disclosure. For example, in the foregoing embodiment, the weld beads 56 are arranged at intervals in the circumferential direction RH of the rivet portion 55 like scattered dots (four weld beads 56 are arranged so as to be separated from each other by 90 degrees in the circumferential direction RH). However, a continuous bead, in which the weld beads 56 are continuous, may be formed. In this case, concentration of heat happens and it is likely that a large amount of heat is transferred to a direct lower part in a seat portion holder on the axially inner side AH1 of the continuous weld bead 56. Therefore, by providing heat transfer inhibiting portions such as a resin recessed portion, a metal recessed portion, and a heat transfer inhibiting member, it is possible to appropriately restrain deterioration of the direct lower part in the seat portion holder.

Further, in the sixth modification, the resin recessed portion 681c, which is a ring-shaped recessed groove, is provided in the seat portion holder 681 of the external insulating member 680. However, like the first modification, a metal recessed portion, which is a ring-shaped recessed groove, may be provided in the insertion hole surrounding portion 157d around the extending portion insertion hole 157c in the riveting seat portion 157b of the negative electrode external member 157. Further, a resin recessed portion, which is a ring-shaped recessed groove, may be provided in the seat portion holder of the external insulating member, together with a metal recessed portion, which is a ring-shaped recessed groove, provided in the insertion hole surrounding portion around the extending portion insertion hole of the riveting seat portion. Furthermore, in these resin recessed portions and metal recessed portions, ring-shaped heat transfer inhibiting members, which are made of porous alumina and so on, may be arranged, respectively, similarly to the third to fifth modifications.

What is claimed is:

1. A battery comprising:
a battery case;
an external metallic member, which is made of metal and arranged on an outer side of the battery case;
an external resin member, which is made of resin, is present between the battery case and the external metallic member, and is in close contact with the battery case and the external metallic member;
a heat transfer inhibiting portion configured to restrain heat transfer from the external metallic member to the external resin member; and
a current collector member made of metal, the current collector member including
an extending portion that extends from an inside of the battery case to an outside of the external metallic member through a case insertion hole and a metallic member insertion hole, the case insertion hole extending through the battery case, and the metallic member insertion hole extending through the external metallic member, and
a rivet portion that expands from the extending portion to a radially outer side of the case insertion hole, covers at least a part of a periphery of the metallic member insertion hole in the external metallic member, and fixes the extending portion, the external metallic member, and the external resin member to the battery case, wherein
the rivet portion of the current collector member and the external metallic member include a weld bead that connects the rivet portion and the external metallic member with each other, the weld bead being made of metal derived from the rivet portion and the external metallic member, and,
when a direction towards an inner side of the battery case along an axis of the case insertion hole is regarded as an axially inner side, the heat transfer inhibiting portion is provided on the axially inner side of the weld bead.

2. The battery according to claim 1, wherein
the heat transfer inhibiting portion is a part where thermal conductivity is lower than thermal conductivity of the metal that forms the external metallic member.

3. The battery according to claim 1, wherein
the heat transfer inhibiting portion is provided in at least either the external metallic member or the external resin member, and is a recessed portion forming a space that separates and thermally insulates the external metallic member and the external resin member from each other on the axially inner side of the weld bead.

4. The battery according to claim 1, wherein
the heat transfer inhibiting portion is made of a heat resistant material with lower thermal conductivity than that of metal that forms the external metallic member, is present between the external metallic member and the external resin member on the axially inner side of the weld bead, and is made of a heat transfer inhibiting member that restrains heat transfer from the external metallic member to the external resin member.

5. The battery according to claim 1, wherein
the external metallic member, and the current collector member having the extending portion and the rivet portion are made of copper.

6. The battery according to claim 3, wherein
the weld bead is formed into a circular spot shape in a plan view, and
the recessed portion is formed such that an outer side surface of the external resin member is recessed in a columnar shape.

7. The battery according to claim 6, wherein
the weld beads are arranged at intervals in a circumferential direction of the metallic member insertion hole.

8. The battery according to claim 3, wherein
the weld bead is formed into a circular spot shape in a plan view, and
the recessed portion is formed such that an inner side surface of the external metallic member is recessed in a columnar shape.

9. The battery according to claim 8, wherein
the weld beads are arranged at intervals in a circumferential direction of the metallic member insertion hole.

10. The battery according to claim 1, wherein
the external metallic member is made of a plate material and includes a riveting seat portion having a flat plate shape, the riveting seat portion serving as a seat for the rivet portion, and
the external resin member is present between the riveting seat portion and the battery case and insulates the riveting seat portion and the battery case from each other.
